(19) United States
(12) Patent Application Publication
(10) Pub. No.: US 2010/0042546 A1
(43) Pub. Date: Feb. 18, 2010

(54) Multimedia (VO) IP Solution for Mobile Telephones

(76) Inventor: Roger Humbel, Baden (CH)

Correspondence Address: BREINER & BREINER, L.L.C., P.O. BOX 320160, ALEXANDRIA, VA, 22320-0160, US

(21) Appl. No.: 12/083,966

(22) PCT Filed: Oct. 21, 2006
(86) PCT No.: PCT/CH2006/000586

§ 371 Date: Sep. 21, 2009

(30) Foreign Application Priority Data
Oct. 23, 2005 (CH) 1703/05

(51) Int. Cl. G06Q 30/00; G06Q 40/00; G06Q 10/00; G06Q 50/00; H04W 4/00; H04M 3/42

(52) U.S. Cl. 705/64; 705/5; 370/338; 455/414.1

(57) ABSTRACT

The invention relates to a novel mobile hotspot value-added service VAS (telephony, internet, IP-TV, M-Payment etc) solution using W-Lan, WiMAX, Bluetooth, DMV, DVB-H, NFC or any other known GSM and UMTS mobile radio technology, with a ticketing system on a handset (mobile, PDA, laptop), said solution being operated as a club system such as Skype for VoIP. In addition to the ticketing system, other rights, duties, or services are carried out/offered/operated or managed, and the operator of the hotspot can make their own profits on the value-added services when they sell the same individually, especially when the handset already contains an electronic ticket (MMS etc). According to the invention, a mobile VAS telephony solution (telephone exchange/platform) is operated as a club system by means of W-Lan, Bluetooth or any other mobile radio technology, such as is known for Skype with VoIP, but not as is claimed in the present invention with mobile telephones, by means of hotspots (with a proprietary software) simultaneously together with and against other rights, duties and inter alia commercial models etc. (such as ticketing systems, payment or controlling in stadiums or trains).

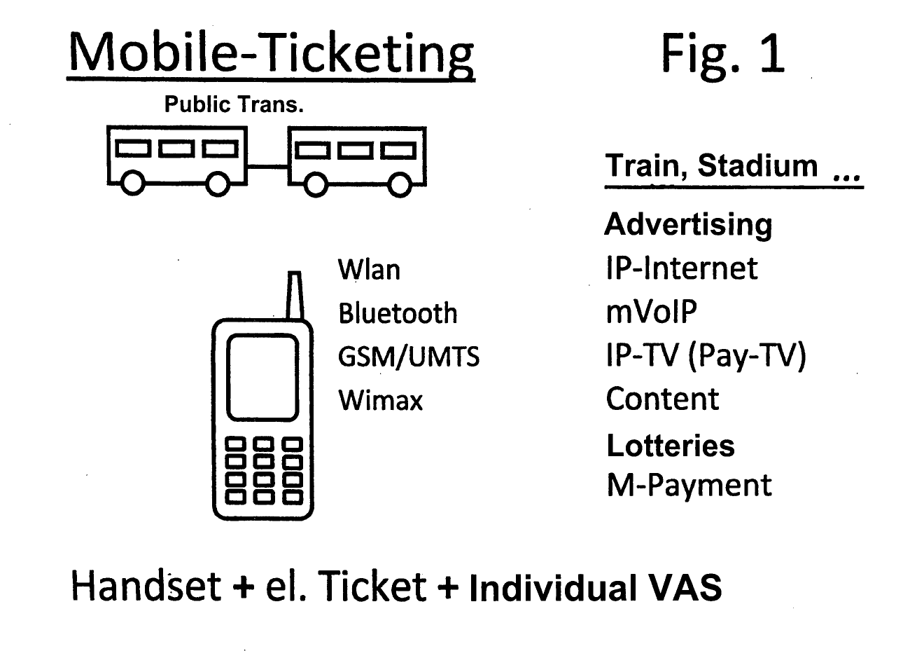

### INTRODUCTION

A new mobile telephony and especially value-added services solution is operated in hotspots as a club system by means of WLAN, Bluetooth or any other mobile radio technology, such as with Skype in VoIP, or more exactly and/or as now (retroactively) with FON in mVoIP, as one of many other individually cleared value-added services available for a fee.

In other words, by means of WLAN, Bluetooth or any other mobile/handset radio technology, a mobile telephony and especially value-added services solution (telephone exchange/ platform) is operated as a club system, as known from Skype with VoIP—but not, as in that case, by means of the PC, but differently, and especially newly claimed, with mobile phones, etc., via hotspots (possibly by means of proprietary software), concurrently with and against other rights, duties, etc. (such as, for example, ticketing, payment or checking/control in stadiums or trains). These mobile ticketing services are especially operated and offered on handsets in the same way as advertising, telephony and Internet surfing, for which, when they operate individually, fees are (or may be) charged by the operator, by which licenses for this protected right are (or must be) issued.

Along with the need to send personalized (individual) tickets via mobile telephones, there is also the possibility, against a fee, to bring telephony (free of charge, for the time being), Internet or even direct TV and direct advertising as value-added services (VAS) to the handsets of passengers and/or viewers. Accordingly, such persons will more probably be willing, notwithstanding their admittedly unjustified reservations with regard to data protection, to use personalized tickets in stadiums. In certain countries (Italy) there is already a “zero tolerance” policy against all possible rowdies, hooligans, vandals, etc., and therefore, such personalized tickets have become compulsory in those countries. For the Europe Soccer Cup, the Champions League, etc., this could be carried out by means of our ticketing solution, just as security as for the airline industry, railway companies, etc.:

Viewers, along with and/or by means of the ticketing, are entitled to make use of “free of charge for the time being” Internet value-added services, such as Skype VoIP telephony, SMS, SMS-Info, M-Payment or IP-TV or to participate in competitions. This combination can also include, for example, an advertisement, which is broadcast before, concurrently with or after the services in question, whereby a license is then required therefor. With our ticketing, viewers can enjoy these advantages in such a way that they must first declare that they are willing to be identified and especially checked (in the EU, due to the above-cited data protection requirements, this is presently critical). Stadium operators, advertising and/or marketing companies and viewers will all achieve great advantages thereby. Bluetooth, WLAN, etc. hotspots can even be set up in bars, parking garages and department stores or by private individuals. In these hotspots, together with the advertising, these free Internet services would be offered to mobile telephone users taking part, for example, in an offered competition—or even buying beverages, food or other products from such a vendor—for which we would then require a license.

### STATE OF THE ART

In 2 and 3 G networks (GSM, UMTS or the new HSDPA (High Speed Downlink Packet Access)), there is no ticketing for events, whereby at the same time the user is offered individual VAS or billed for them. Only telephony is individually charged; no other Internet value-added service is individually billed—that is, such services are available, and are billed, against a flat rate only. But the Internet value-added service is not individually billed with the ticketing; moreover, and more importantly, such ticketing with individual Internet value-added services for events, parking garages, public transportation, and so forth does not yet exist.

Furthermore, generally speaking, the hotspot operator makes money out of Internet value services according to a per-minute or per-hour flat rate, but not on an individual basis for each Internet value-added service. For example, the Cloud or Yellex operate such general mVoIP flat rate building, but do not individually clear each and every mVoIP call or other VAS.

There is VoIP, but not individually billed from mobile phones via WLAN to club members. In the case of Skype, it would be technically possible to offer it from mobiles via WLAN; this, however, is neither offered nor promoted by Skype, etc., nor is the possibility offered of using mobile phones via hotspots by means of appropriate mobile phone software for WLAN, etc. In addition, present-day hotspots are private or limited by operators, and are not public, and the VoIP involved is always offered against a fee and provided via a commercial (UMTS) network operator.

To date, there have not been such Skype hotspots in railway stations, stadiums, cinemas, restaurants, where all of these hotspot operators offer individually cleared Skyping free or at their tariffs. There are also attempts by Skype users to Skype via UMTS networks; this, however, is prevented by the operators by means of appropriate Skype suppressors.

It is admittedly possible to pay for WLAN surfing, which would also enable Skype—for example, in airplanes by means of a credit card (but not with mobile phone, PDA, etc. software). This payment, however, does not include payment for all other rights and duties, such as lights, beverages, Internet services, etc.—especially not with biometric or PIN identification. obviously, it is also possible to obtain other services via VoWiFi (Skype-Mobile); these, however, have not been either offered or even described as available by hotspot operators as part of a package together with their exclusive rights and duties for payment, ticketing, checking/control, advertising—and accordingly, our system of VoWiFi Skype-Mobile rights, duties and especially telephony payments, checking/control, advertising, etc. is new and inventive from the standpoint of intellectual property rights.

SMS ticketing (identification and billing via the mobile phone SIM card) is available in trains. To date, however, no additional simultaneous (free) services, rights and duties are offered and operated by means of that arrangement. In trains and airplanes, it is even possible to have WLAN with all services, and to pay for it by means of a credit card, but not with ticketing/identification/checking/control for the transportation itself (travel fees) and/or this new service (because the service did not even exist, or because the payment, which in any event involves neither ticketing or personal identification, serves (or served) for everything else)—and this is what is now being claimed in/by means of this new Mobile-Skype patent—especially with NFC, PIN and biometric fingerprint sensor or voice and/or face identification. The operator of a radio network, at the time of and/or along with personal identification/ticketing/payment, can demand fees for advertising and all other services (Mobile-VoIP). In other words, if an operator offers services and advertising, it must be paid by the user, according to this patent, for licenses for individual personal identification services, as well as for (NFC) payment/ticketing services.

Credit cards are not directly connected to any mobile telephone, and mobile phone SIM cards are not precise means of personal identification. Accordingly, the NFC or PIN identification, together with ticketing/checking/control, is new and inventive, and allows the operation/offer and/or the licensing of exclusively protected common Mobile-Skype services and/or Internet value-added services.

This new patent is new, because we do not use SIM card or credit card identification for service authorization; rather, we offer (((NFC))) ticketing/checking/control together with Mobile-Skype services. In other words, checking/control is not and cannot be performed by means of a credit card. Furthermore, in the case of SMS ticketing, etc., no Internet value-added services are yet combined. Accordingly, even relative to WLAN for GSM, this should be considered new and inventive and, in any event, is already practicable. Instead of GSM and UMTS, users would rather use—and in fact, will use—the less expensive hotspot Internet value-added services.

Ticketing and advertising via WLAN is certainly not (necessarily) something new; together with Internet value-added services on mobile telephones, however, it is. Skype and advertising are already operated in England (The Cloud) and in aircraft WLAN hotspots, but ticketing on mobile phones is not. For this reason as well, this is a new patent. In England, Broadcast has opened VoIP hotspots in railway stations for Skyping—generally against a fee. Nonetheless, they do not offer combined ticketing, and especially do not enable Skyping in the trains themselves. That is, precisely in clearly delimited areas, spaces especially governed by exclusive operators and service rights, no Mobile-Multi-Media-Skype is yet offered.

In other words, although the classic hotspot tariffs for Internet access already exist, whereby even mVoIP would be possible, the value-added service is not individually billed in such places; rather, generally speaking, only the hotspot surfing time is charged. For this reason, the mobile ticketing patent is new and inventive, and is not obvious—because precisely in this way, every value-added service is additionally and individually charged, even when the use of the hotspot also costs money. The Mobile VoIP, in hotspots with solutions involving a fee, constitutes ticketing per se (for itself, i.e. for telephoning); in such hotspots, however, which simply offer hotspot surf time telephony, (to date) no “ticketing” is used for a respective value-added service (for example, even for VoIP); rather, only an Internet connection is offered. It has long been possible to measure data streams; nonetheless, individual pay-as-you-go services have not been offered on hotspots, which is debited, as set forth above, by means of a single charge. (Note: the Microcom Wieland Manager has only officially been in existence since November 2005, and no other billing manager reports on individual Internet value-added services, which run within one ticketing.) Authorization—that is, access accompanied by ticketing for value-added services in hotspots—especially did not exist. For this reason, mobile ticketing is also new, inventive and not made obvious by the state of the art, for individually charged (cleared) wireless mVoIP in hotspots as well. It is especially new and inventive in hotspots where local and/or roaming ticketing/voucher/advertising is used with one value-added service (such as VoIP) for any other offer or even for another value-added service (Parking, IP-TV, M-Payment, VoIP itself).

The mobile ticketing patent could be circumvented and/or could be shown to have loopholes, if public transportation did not make use of ticketing with mobile phones, but simply remained with SMS and MMS. In such a case, (our) MMM-IP could never be made—that is, Internet value-added services could never be offered—with the SMS and MMS tickets, because the mobile phones would then be in breach of this mobile ticketing patent. In actual fact, however, there is (almost) no loophole, because, with both earlier and later mobile phones, MMM-IP is made simultaneously with SMS and/or MMS, as well as with other mobile ticketing, meaning that the mobile ticketing patent is then breached.

In hotspots, to date, only general connections are possible, but not individual value-added services, which are especially combined with local ticketing. Not even individually charged (cleared) mVoIP is offered separately as a value-added service.

In addition, in the case of advertising—for example, inside shops—to date, there are no hotspot solutions in which value-added services are altered or advertising is implemented by outside firms and cleared at the hotspot. Some shops have run advertisements and/or special promotions for themselves; however no cases which involve paying an external provider for such advertising via the hotspot are known to date via either Bluetooth (Beamzone), WLAN, or GSM and UMTS. In any event, in the case of UMTS, the provider (operator) is not paid advertising royalties; this is only done in the case of content providers (TV channels) operating as a business.

The only prior art WLAN patent found is the WLAN Roaming patent by Togewa US2006/0004643, “Method And System For GSM Billing During WLAN Roaming”. That patent does not mention either individually cleared or seamless VAS.

### Innovation:

For the (SIM-based and/or SIM-less) solution of Mobile-Multi-Media-Skyping (individual value-added services/ticketing/voucher or SMS/MMS)—inter alia, including a workaround for the problem of suppression by operators—there is now our newly invented alternative, which constitutes the object of the patent application, of Skyping via hotspots with mobile telephones and/or individual value-added services together with and against other rights and duties, etc., which are especially operated and/or offered in the context of personal identification. This solution, by means of proprietary or other mobile phone software, is not offered by the established Skype and Sipcall VoIP operators together with transportation operators, department stores or stadium operators.

The solution enables mobile phone users, even on the go, to use mobile VoIP (Skype) and to consume individual value-added services, together with and against other rights and duties, such as payment, ticketing, Internet surfing, Internet-TV, etc. To this end, a telephone exchange/platform with VoIP and the individual value-added services is operated on the Internet, which constitutes a one-of-a-kind club providing access for radio (W-LAN, BT, UBW, etc.) mobile phones, with appropriately configured software, especially whereby said software is authorized by the telephone exchange/platform. (This mobile phone software would enable seamless switching from one hotspot to another, without interruption, even if the user changes his or her position, and would enable the use of VoIP by means of different radio systems in places with large numbers of mobile VoIP (Skype) users.)

In order to guarantee the ticketing, a mobile phone with a telephone number and/or SIM card is sufficient, because, as soon as the mobile phone is stolen, it can be registered and/or deregistered. Even the use of one mobile phone by a plurality of persons is not possible, because all services and payments are linked only to the number in question, and, in any event, in future, the services (should) only operate with personalized identification by means of a biometric fingerprint sensor or voice recognition.

Even in the case of interactive DMB, DVB-H, mobile TV within the ticketing (frame, station, club, etc.) with combined handset identification/authorization and primarily access to the content provided by the ticketing entity or by the operator, this is also a mobile ticketing value-added service, especially once interactive TV is provided to the mobile phone and fed back via hotspots or GSM. For this reason, every operator will have to ensure that the content provided by the ticketing entity or by the operator is not itself offered, and that a ticket cannot be ordered, or authorization provided, via the mobile phone. This is because this also does not yet exist and is therefore also new and inventive. Moreover, direct simultaneous or time-delayed access to the content provided by the ticketing entity should not be offered along with the ticketing, without the payment of a license fee.

As soon as an M-Payment is made within the WLAN network, a license fee must also be paid for the MMM-IP. This will mean that NFC M-Payment will admittedly become very expensive; however, the constraint that no other M-Payment is available makes it impossible for users and providers not to pay us the license fees, because otherwise, they will always have to give up on something. This is a reason to introduce more mobile cash points, and primarily the AIORK software and/or M-Payment, on mobile phones. Because this does not yet exist on handsets (only SMS or RFID, but not with WLAN or Bluetooth), and accordingly, this is new and inventive—especially identification by means of a fingerprint sensor, NFC transmitter or RFID tag.

To date, in places with hotspot advertising (such as in shops, filling stations, parking garages, etc.), client data (especially mobile phone data) have not yet been transmitted via the Internet and a server for additional hotspot-based value-added services (ticketing, advertising, payment). To date, it has not been possible to configure mobiles in such a way as to allow interactive applications to run on them, and certainly not to allow them to access additional (primarily pay as you go) services via the Internet and a server. At most, it has been possible to implement special promotions or to transmit notices or price data.

In the case of ticketing by parking garages, cinemas and trains, hotspots can also inform users of exclusive unoccupied seats/places, etc. Such offers, when made together with mobile ticketing, would have to involve the payment of a license fee to us. In other words, in the case of ticketing by a parking garage, unoccupied parking spaces and MMM-IP could only be offered subject to the payment of a license fee. This means that the display of unoccupied parking spaces and the use of mobile ticketing at the parking garage via WLAN would only be possible once the license fee was paid. In other words, anyone who wishes to display unoccupied parking places could only do so with our solution; otherwise, they would have to waive mobile ticketing. This means that they would not be able to display unoccupied parking spaces via WLAN . . . Hmm. Do they already have this??? Yes, they do (with GSM), but they don't perform identification at the time of parking with the hand-held device via WLAN (only GSM). But displaying by GSM is expensive . . . and performing identification and offering MMM-IP via WLAN would only work with the payment of a license fee to us.

Skype with Fon is now trying to push itself into this new, large market. In this context, the high hourly tariffs of hotspots always constituted an entry barrier for users. The use of private, business and public hotspots as distribution networks is preserved in this mobile ticketing patent as a basic principle. The only thing is that the tariffs in public hotspots were general, and were charged per hour and never individually per value-added service, although to do so would really have seemed quite obvious. The fact that the entire WLAN world in public hotspots charged by means of general hourly tariffs and never offered a value-added service, such as wVoIP, due to the high hourly rates—not to mention offering such services on an individually cleared basis—is the only reason why this does not exist to date. This is also why individual value-added service ticketing for wVoIP can be considered as new, inventive and not made obvious by the state of the art.

Right after “1com managed” by Sunrise/Cablecom, we saw the appearance of a second product which breaches our mVoIP patent: that of Eteleon. In the case of roaming in other (GSM, UMTS, Bluetooth or other) networks as well, mVoIP as a VAS is claimed and is subject to license, because otherwise, it would be easy to get around it. In other words, we invented precisely that, and therefore it cannot be gotten around by means of the argument that people are getting around it now, or could possibly get around it now (with free mVoIP in the GSM flat rate or subscription package). People still have the choice of offering only a single general connection for 0-X Fr. or paying us for several individual VAS licenses. A flat rate with free mVoIP would be possible, but in such a case, GSM would have to be free as well, and this again would mean that VAS were concealed in the flat rate; alternatively, even if the GSM call itself were free, this would again be a flat rate with concealed VAS . . . Even in the case of services obtained for a fee over the Internet via hotspots, the VAS was not individually cleared; rather, only (or not even) the Internet connection was paid for, and the hotspot operator, in any event, did not make any money from such a VAS (except for the Internet connection, e.g. in The Cloud or Boingo). Nor do (did) the Cloud, etc., offer roaming in GSM or other networks.

This mobile ticketing patent encompasses the various other possibilities for providing value-added services which, to date, have not been offered by providers. This means all other models except that of general per-hour or per-minute tariffs. It might even be possible to offer subscriptions for a flat rate—especially when there was already an electronic ticket on the handset.

The innovation of mobile ticketing, compared to hotspot services on a subscription or contract basis, is that a provider of other services, even combined with its own service, can now offer yet other IT and/or Internet services, i.e. value-added services.

### Other Patents:

1) Roamware: U.S. Pat. No. 7,072,651 Method and system for cellular network traffic redirection von Jiang, et al. Date of publication: Jul. 4, 2006

2) Togewa US2006/0004643, “Method And System For GSM Billing During Wlan Roaming”.

3) Zoltan Pal WO03047283 METHOD FOR OPERATING AN ALTERNATIVE MOBILE TELECOMMUNICATIONS SYSTEM AND FOR PROVIDING SERVICES, Date of publication: Jun. 5, 2003

4) Zoltan Pal WO2005010788 METHOD FOR ACCESSING A PACKET-SWITCHED NETWORK FINANCED BY A PROVIDER FOR ELECTRONIC TRADE AND PAYMENT AND FOR RUNNING A TELECOMMUNICATION SYSTEM BASED ON A PARTNERSHIP BONUS PRINCIPLE, Date of publication: Feb. 3, 2005

5) ISAAC STEPHEN JOHN WO03071489 TICKETING SYSTEM OPERABLE BY MOBILE COMMUNICATORS, Date of publication: Aug. 28, 2003

6) MAK MICHAEL MAN HO (AU) WO2005083640 MOBILE TICKETING, Date of publication: Sep. 9, 2005

7) LLOYD IAN (AU); PARKER ANDREW (AU); WO2005091228 MOBILE TICKETING SYSTEM, Date of publication: Sep. 29, 2005

8) WU QUEN-ZONG (TW); LAN YUANG-TZONG (TW) GB2423853 An electronic ticketing system in which colour barcodes are displayed on mobile communication devices, Date of publication: Sep. 6, 2006

9) KIM JAE WON (KR); OH TAE HO (KR) KR2002094395 METHOD FOR TICKETING SERVICE BY USING MOBILE COMMUNICATION TERMINAL, Date of publication: Dec. 18, 2002

10) YANG CHANG YEONG (KR) KR2002033714 SYSTEM FOR OFFERING AUTOMATED TICKETING SERVICE BY REDUCED DIALING IN MOBILE INTERNET PHONE, Date of publication: May 7, 2002

1 and 2 describe and claim roaming solutions, which can be misunderstood by the speech (use) with the seamless change in other nets. Roaming is to have a connectivity in other/foreign nets (Abroad respectively in another country).

3 is a solution, where no tickets over GSM, Wimax and NFC are claimed, where at the same time also value-added-services are offered, which are paid but where no value added service are claimed respectively no such service is sponsored over advertising or third parties.

4 is a Packet-Switched solution, which does not claim GSM telephony -but only other packet-services. The payment is not client/customer based, but only “provider-based” respectively “offering-financed”, i.e. not with or at the purchase of a product (as with 0800 numbers, but not only with an electronic ticket on the handset on the handset) “customer-financed”.

5-10 are all ticketing-systems, which do not claim value added services.

### DESCRIPTION

1) Mobile radio and TV and multimedia, etc. Internet value-added service and packet-switched service ticketing solution, wherein, via WLAN, Bluetooth, GSM, UMTS, HSDPA, WiMax, DECT, UWB, UKW, satellite, DMB, DVB-H and NFC or any other mobile radio technology, a club system is operated, in which, from an Internet/radio/TV/telephone exchange platform with value-added services, content, multimedia and mobile VoIP, in one or more sessions by means of one or more/further (additional) hotspots, this mobile telephony and value-added service solution, whether charged individually and/or generally with the Internet connection, is operated for mobile telephone users, and wherein services which are subject to additional personal identification, such as PIN or biometric ID (fingerprint)—especially also at NFC terminals, etc.—payment, ticketing, Internet surfing, Internet TV, pay-TV, consumption-, registration-, authorization-, security-, time-, place-, and rights-dependent services and value-added services, such as premium SMS, Messenger or advertising, operated and/or offered to said users (on their devices)—especially in combination with other rights, duties and services for users, entitled and/or authorized parties (mobile hotspot value-added service users), whereby such hotspot ticketing, which is subject to a local fee and generates income for the operator, with tickets, subscriptions and other electronic vouchers, is operated on mobile telephones, and whereby any other type of authorization, participation, entitlement, purchase or acquisition, via the mobile telephone, of the IP value added services, such as Mobile VoIP, includes Internet, IP-TV, M-Payment, advertisement, mobile parking, lotteries, premium SMS, content as a whole and other such groups/bundles or reciprocal exclusions, such as content without advertising.

2) Mobile phone ticketing solution according to point 1, wherein, in shops, restaurants, etc., said solution enables the mobile hotspot by US service users to obtain special offers, when they select the service with or without personal identification, and wherein advertisements and infomercials are switched in before, during and after the use of the mobile hotspot value-added service, according to specific user profiles, and wherein, in sports stadiums, replays or even Internet-TV can be displayed by means of this mobile hotspot value-added service offer, so that, along with a value-added service, and especially with a local and/or roaming VoIP, ticketing/vouchers/advertising for any other offer, or for any other value-added service, such as parking, IP-TV, M-Payment or VoIP itself, can be implemented/operated on the mobile phone.

3) Mobile telephony solution according to point 1, wherein in places with several mobile phones under a single hotspot several phone calls can be operated.

4) Mobile telephony solution according to point 1, wherein in one or more sessions of one or more different types of access points (Wi-Fi, Bluetooth, Wimax, GSM, UMTS, etc.) changes in the local hotspot to hotspot are smoothly seamless running and wherein a clearing is provided individually or generally as a flatrate-contract.

5) Mobile telephony solution according to point 1, wherein in places with several mobile phones under the individual and the various hotspots Walki-Talki-telephony is provided and local changes in the hotspot to other hotspots are seamlessly and smoothly running.

6) Mobile telephony solution according to point 1, wherein in addition to the mobile-Skype and the additional services even acoustic and visual advertisements and information services are provided or offered.

7) Mobile phone ticketing solution according to point 1, wherein, by means of said mobile hotspot value-added service offer, department store, public transportation, railway and stadium clients are given an alternative, including a mobile alternative, to (NFC Chip) payment and ticketing (i.e. are authorized and/or the tickets are charged), and along with this (PIN-SMS, email, etc.) ticketing, direct entitlement to said mobile hotspot value-added service offer in trains, stadiums, theaters, cinemas, etc., is provided and/or given and/or guaranteed, and wherein ticketing security and general personal security is enabled before entry, during transport and after exit, including directly for the providers (public transportation and stadium operators) (whereby said security, notwithstanding the fact that personal data are collected, guarantees data protection according to the basic principles of the operator and/or the network), thus enabling an (ingenious) possibility for operators of public and private transportation and football stadiums to control vandals, idlers and hooligans, (because) by ensuring that all of said mobile hotspot value-added service users, with authorizations installed on the mobile telephones, are always subjected to this ingenious means of control.

8) Mobile telephony solution according to point 1, wherein for these Skype mobile radio services, with or without the additional services and services is a pin, or other biometric identification with Fingerprints nor or voice recognition is required or provided or collected automatically, with a device to control even once during the customer-transports must have been switched so that registration could be levied.

9) Mobile telephony solution according to point 7, wherein personal NFC smart cards, trailers or mobile phones or other payment solutions, or other identification media the Mobile Skype and its additional services can be authorized or a withdrawal of reader-especially in the hotspot area or in and about mobile phones.

10) Mobile Skype partners, the hotspots of their additional services available on customer preferences for their mobile hotspots offered and operated, or so only to certain times, places, rights, obligations, these hotspots automatically preferred selected and called.

11) Mobile Skype with or without biometric identification media such as v.a. Fingerprint sensors and equipment, handsets, phones, PDAs, PCs and mobile phones together with the common contact less payment solutions via NFC, contact magnetic strip and the cash system or other Internet Payments pin runs.

12) Audible or visual communication on a device when it is entering into a mobile Skype hotspot area.

13) Mobile telephony solution wherein on the phone screen pixels or advertising space will be acquired or bought.

14) A time window is acquired or bought by a pixel auction with mobile-ticketing.

15) Mobile Skype and Internet telephony solution, wherein over the hotspot licenses areas, rooms, etc. and times legally can be acquired or bought.

16) A mobile Skyper can manage (secure location, buy or acquire etc.) over this club membership lock-loop products.

17) TV video advertising (GSM, UMTS, Bluetooth, WiMAX, DMB, DVB-H, etc.) WLAN (Skype) hotspots and clear, free or open defined locations, times, rights and obligations contrary to and in conjunction with telephony, messenger, payment, surfing the Internet or SMS, NFC, credit cards, etc. barcode ticketing for special user configuration on the handset.

18) Mobile phone ticketing solution according to point 1, wherein, by means of Internet links to the video advertisements, access to the advertised Internet sites is provided, whereby, by clicking on the advertising link, a fee is collected, which must be paid by the advertiser to the mobile hotspot value-added service provider before the link is opened/forwarded, and wherein advertising links must be paid for according to click frequency, size and length, as they appear on the AIORK software, for which an (entirely transparent) AIORK calculation software performs the cost calculation for each advertising link, whereby predefined framework conditions with regard to fees are set for an advertising banner or advertising jingle, and whereby, in advertising spaces recognized in the free Web—which are not authorized by us, and which are visually and electronically marked—the finder receives a credit (e.g. 1% of the annual turnover of the advertising link, or a lump sum) and the same fee principle applies to all other Internet services offered via mobile hotspot value-added services; otherwise, the payment, ticketing and all other control and security services, or precisely the entire hotspot, are blocked/discriminated by the AIORK software. 18)

19) Stations and trains manage at the same time controlling for ticketing. At airports phone with NFC chip and FP sensor is also direct VoIP Skype free access on the plane, with the user about his personal identification pin or on the NFC authorization for the mobile Skype services a place. In stadiums and parking garages along with ticketing Mobile Skype services.

20) Skype roam to e-mail address, to Dect with Skype to GSM work seamlessly.

21) In addition to NFC, Bluetooth, IrDa, W-Lan based identification transactions are using biometric voice recognition on mobile phone, PDA, headset and controlling the identification for the Skype services, rights and obligations incurred authorization.

22) One or more person(s) can be identified with a medium (card, device, mobile phone (with FPS or pin), PDAs, etc.) about one or more technologies (NFC, SMS-(ticketing), bar code from one or more providers in one or more locations, dates and time periods on various rights and obligations telephony, ticketing, payment and advertising services, etc. and operate in conjunction with the control, authorization, identification, and particularly that of ourselves individually and rendered usable passenger safety.

23) Mobile phone ticketing solution according to point 1, wherein private hotspot operators offer advertisement and mobile hotspot value-added services (as is already claimed in the AIORK patent)—both without and with identification/control or ticketing/payment. In other words, any combination and/or exclusions of advertising+mobile services, advertising+identification/control, advertising+ticketing/payment, identification/control+mobile services, identification/control+ticketing/payment, mobile services+ticketing/payment, mobile services+ticketing/payment+identification/control, mobile services+identification/control+advertising, ticketing/payment+identification/control+advertising or mobile services+ticketing/payment+identification/control+advertising, is possible.

24) Internet services in particular for Web-TV reception is mobile interactive services to Skype, where the display, etc. accompanying services and applications to the current program are presented.

25) The mobile Skype phone software has/offers the best connection fee rates for calls.

26) Mobile phone ticketing solution according to point 1, wherein ticketing is used in bars, clubs and restaurants, etc., whereby appropriate mobile hotspot value-added services are offered for competitions with tickets or, for example, beverage credits, whereby said mobile hotspot value-added services can be obtained by means of the dial-in ticket code visible on the TV, flyers, beer mats, etc. and, against identification, additional (free or reduced-Price) offers of beverages and food can be obtained.

27) The main hotspot save the big Web and TV content, so they always without delay through the narrow Internet connections immediately are available for the Mobile-Skype users are available.

28) Mobile Skype services include advertising, Internet and TV, etc. also upload the data and M-payment with and without NFC and with and without fingerprint sensor on the (Java) equipment. (In aircraft KK is no longer free of charge and one has to pay, so Skype and mobile ticketing can be offered. The same principle applies to public and private hotspots, where even telephony (Skype) is no longer free may be without payment for advertising and anyway a license to pay, because payment for a license there is only exclusive to us, even if only in our mobile Skype services are received. This means that telephone calls to and from private and public (Skype) Hotspots will be with us for the termination fee as well as for the commercials as Jamba preselected Jingles.)

29) In an airport, etc. Wireless, BT and GSM networks, etc. passengers SMS information about boarding, departure time or other messages on their mobile phones, etc., where the ticket-buying customers, buying and mobile identification number to be saved for the legitimacy of the Mobile Skype services (Internet, telephony and advertising).

30) About W-Lan, etc. can in stadiums, trains, department stores interactive TV settings ads, slow motion, etc. are managed.

31) The Voice over IP systems are in desk and laptops from companies whose employees installed that automatically on each W-LAN or transition, etc. Bluetooth transmitter can run, with a corresponding software on the phones like the desktop or about the laptops regulates courses.

32) Software regulates the cost of different applications and for the scheduling of other suppliers.

33) The ticketing is also true for other devices than phones, PDA or laptops, but also for vehicles, suitcases, bags, clothes with the RFID tags and radio stations are equipped.

34) The ticketing is also true, or even in taxis and private hire vehicles, where their use and MMMIP content with the personal ticketing deducted. Combined with the ticketing and the MMM IP, there are games.

35) A software controls the billing for the various links, content and payments or other written or other entries for transactions within the mobile ticketing, where users themselves license payments and links, content and Payments can report and a royalty on sales.

36) Ticketing can mean the handset itself, or of any new media is not yet known as NFC, the electronic identification of the Web, Internet, or W-LAN or GSM, etc. on a handset is allowed.

37) In department stores or bars, etc. competitions or offers as a ticketing operation, where such participation by an authorization for the MMM-IP services within the department stores or bars, etc. can occur.

38) Hotspot operators shall receive compensation for offering the Hotspots within various wireless operators, where once a local ticketing or a local competition with a personal identification of W-LAN will end this license. The users can report such ticketing and competitions.

39) For Copy Rights, any license from the users themselves may be.

40) In private and public hotspots for the Mobile Log charged a fee, by analogy, the former telephone booths tariffs. N.B. for all such local Wi-Fi VoIP value-added services should I use the mobile ticketing patent, especially when Internet telephony selectively, or advertising-TV, or a specifically defined user tickets for local or consumptions, competitions, etc. buys (is a bit difficult for present vending machines, because in trains and stadiums is the simple principle . . . ). Your suppliers (cola, snacks, etc.) as this will directly make advertising and competitions . . .

41) It can directly be rented or purchased on hotspots web space,

42) A direction indicator shows the strongest hotspot networks and selects the strongest

43) For vehicles, there are outdoor W-LAN, Bluetooth, etc. Wimax antennas, which have particularly strong reception guarantee and a plug and play kit extension guaranteed ticketing on motorways etc . . .

44) Together with the handheld NFC Payment is the mobile ticketing or personal individual, because people dislike their wallets (I.e. the handhelds/phones for the M-Payment) from the hands . . .

45) Interactive DMB, DVB-H mobile TV within a Ticketing (train, stadium, club, etc.) combined with handset identification/authorization is also a mobile ticketing value-added service.

46) RFID tag Registration/identifications/M-Payment via mobile boxes or otherwise owned—NFC reader is also a ticketing, where at Club, restaurant or shop, etc. admission also the hotspot value-added services can be offered. I.e. our operation as soon as an M-Payment (NFC or GSM RT-Payment), access control and ticketing, he is responsible for the content MMM-IP license.

47) With Hotspot-advertisements (e.g. in stores and gas-stations etc.) the data of the clients are used over internet and servers (especially data of the handsets), which then are used for further Hotspot based value-added-services (ticketing, advertisements, payment), wherein the handsets are then so configured so that interactive applications get going and so over internet and external/internal servers further (especially services with cost) value-added-services get triggered.

48) Mobile phone ticketing solution according to point 1, wherein, for mobile parking ticketing, unoccupied parking places are announced and reserved on the mobile telephones by means of all radio standards, and wherein said ticketing can also be operated online, with the same reservations, in and with cinemas, airplanes, trains, restaurants, and wherein automobile drivers can simultaneously obtain the mobile ticketing Internet services while in the parking garage.

49) A link (against a fee), or a function for obtaining good free offers, is integrated into the mobile ticketing, and wherein free content constitutes a form of value-added services which requires a license.

50) A mobile ticketing is an automatic identification or run with an active verification on the handset or an active act (device to lay reader). Calls on a phone without a connection, a ticketing triggered, where on the handheld and value-added services offered . . .

51) A (paid) link or a function to free offerings is good in mobile ticketing integrated and free content license are a form of value-added services.

52) In conference calls an editor can open and covert messages are exchanged, election to be made or completed deals with authorization (for example on fingerprint sensors)

53) Voucher can be ticketed via SMS, W-LAN, Bluetooth, NFC, GSM operated and offered to the handset (hotspots).

54) On the mobile ticketing platform, “Web miles” for surfing on certain sites and above all in the various value-added services offered, which in turn further value added services.

55) With the mobile VoIP it could also simultaneously manage an editor of the various interlocutors participants graphical representations and written messages on a platform/editor/area/Sheet. Excerpts screen, monitor or transfer program transfers to other mobile ticketing users will be offered.

56) Extension kits with W-LAN hotspots are used as channels to PCs through a Bluetooth or W-LAN or USB interface . . . .

57) A “mobile” hotspot mobile ticketing solution is through a plug and play with handheld/Extension kits or fixed “radio locks” for vehicles with car number or Chassinummer and/or phone number identification for admission/Ticketing on the road in the Offices/Government/Police.

58) The mobile ticketing (particularly for advertising and vouchers) Extension kits with (fingerprint sensor) NFC Payment is authorized

59) A software in the Extension kits and mobile phones or handheld turns TV reception of W-Lan hotspot or Bluetooth to VHF and satellite or otherwise to UMTS reception so that the Ticketing for IP-TV value-added services always (to any place).

60) A mobile ticketing on UMTS, GSM is as new and inventive, because with a current SMS or MMS-ticketing not only automatically value-added services are billed individually, but generally there is only the minute billing for connecting to the 2 and 3G network. I.e. on each network, where a mobile ticketing and individual value-added-services are offered and paid for, are licenses to pay us. An example x Smart tickets to an event also entitle value-added-services is not yet available for free except for information or advertising voucher for the event itself. But the market is not yet . . .

61) For unidirectional transmission media, such as VHF radio or terrestrial, digital (DVBH) or satellite TV, via/with/upon mobile ticketing via WLAN or Bluetooth Hotspots and/or GSM and UMTS networks, feedback messages for all additional services are allowed to reach the unidirectional transmission media, whereby (for example), upon/for/after advertising, direct purchase/voting/reservation is possible.

62) Personal individual add-ons in physical and electronic form are offered with the Mobile-Ticketing.

63) On the handsets all (running) increase in value services are shown graphically on one single surface and for managing co-ordinates in particular TV-Contents and streaming video increase in value services shall be managed in parallel on a surface . . .

64) Also about adaptor in PC and laptops Mobile-Ticketing can be offered, while the adaptors with every hand hero an inquiry does for logging in etc..

65) It can be volume based or time based individual and general value-added-services are subtracted in the Hotspots . . .

66) A central server makes/manages/hosts the clearing for the individual Hotspot the increase in value services which are offered with software in the single Hotspots . . .

67) When referrals of the value-added-services of mobile Wlan handset to other handsets or AP adaptors etc. these referrals also become subject to licensing . . .

68) In hotspots in public and private places, public authorities, schools, companies, shops, etc., handsets and especially extension kits are configured to specific user rights and the users and/or their handsets can be charged with fines/penalties or tariffs, against a fee, and wherein especially any user traffic can be individually controlled by the hotspot operator.

69) Mobile ticketing may be understood to include mobile paying, i.e. wherever direct—especially NFC and SMS—payments are made, VAS for which a fee is charged are subject to license fees, or wherein, instead of individual charging for VAS, a time-based (leasing) system of charging for VAS may be activated.

70) With the downloads liable to pay costs which may be sold not transmitted, or be copied only already an inquiry is done chronologically successive with reproduction with the central server the authorization . . .

71) IT value-added-services can be acquired on the way and immediately lives to or on another server/computer become saved . . .

72) Instead of individual account value-added-services can be also effected chronologically decreasing (leasing) clearing.

73) IP TV and such IP Content is offered as more individual and individual per canal and time or subscription for a package (time, times, transmitters, broadcastings, canal, canals, services) of subtracted value-added-services on Handhelds about WLAN, DMB, DVB H or UMTS . . .

74) Mobile-Ticketing Ticketing and Contents are delivered on extension kits where they are passed on then further on playback devices . . .

75) Value-added-services are taken over fluently from physic Internet binding Wlan in GSM and UMTS or DMB, DVB H T, page or C nets to changes on the Handhelds and are debited a sum to an account in the new nets immediately also individually or then as a flat-rate.

76) Free parking bays or other value-added-services can become Point Of Interests directly in GPS navigation systems and shown with every new Hotspot update . . .

77) Traffic signals, traffic controls, emergency scenarios are offered for free or at the owner's expense within the Hotspots . . .

78) Mobile phone ticketing solution according to point 1, wherein, in hotspots, services with subscriptions or flat rates or free offers, or also sponsored services subsidized, for example, by advertising, may be combined with each other and roamed in local or foreign networks, whereby the concept of ticketing is decisive: Should an electronic ticket (billed or free authorization) be generated, the service applies to the user in question in all hotspots, and is cleared by a company, or may also be cleared by a plurality of (independent or sponsored) companies. Should a user in or from a GSM/UMTS network enter a WLAN network with a more attractive tariff or sponsored service, the client selects and switches in, by means of the mobile telephone, the most attractive, best or fastest provider (GSM, UMTS or WLAN), whereby said provider does not only clear said services individually at the most attractive rate, but may also provide them at a flat rate or as sponsored services. Should a client leave a sponsored or free or pay as you go hotspot and roam into a local or foreign pay-as-you-go or free network, said user shall again perform ticketing in said network as a service.

79) Mobile telephony solution according to point (78), wherein the increase in value services with a Fingerprint sensor or a Call-Purchase key on the hand set are authorized for the purchase and clearing.

80) Mobile telephony solution according point 1, wherein advertisement become liable to license in the different possible Bluetooth, Wlan, Wimax, GSM, or UMTS in connection with another Ticketing

81) Mobile phone ticketing solution according to point (80), wherein the VAS that are offered via a hotspot (WLAN, Blue-tooth, NFC) in the territory in question are subject to a license fee, even if the ticketing was applied to the device by means of another hotspot (UMTS, GSM). This shall also apply to users who hopped into WLAN networks or via inter-connected WLAN networks with OLSR protocol into a local MAN network—for example, from WLAN via WIMAX to WLAN, and are thereby connected by means of a hybrid network.

82) Mobile telephony solution according point 1, wherein marked that with IP TV the license fees are paid for the Hotspot consumption by a combined individual time, data volume and/or unique subscription fee.

83) Mobile-Ticketing-Points run like with MoviePoints. Users of this receive it also if they win over new customers or begin other users a download from own MovieBox.

84) Value-added-services as for example VoIP on the Internet, but also on handhelds, can be activated with a link at the owner's expense. The link must be clicked or be activated with an authorization . . .

85) IT value-added-services from the Internet which do not have a value (an additional value) in their general sense, i.e. above all free services are offered and sold over the Hotspots as liable services with costs in the Hotspots and which are commercialized from the Hotspot-Operator for which we will take over the clearing . . .

86) Mobile-Ticketing is also over GSM/UMTS or, otherwise, on an Asterisk Telefony-System value-added-services are unwound or are done.

87) The hand set client calculates and puts graphically directly from the location over the different nets of the different operators, carrier and VoIP supplier what is the most favorable rate for a suitable phone call.

88) Interactive TV shows, lotteries and competitions are pursued about Mobile-Ticketing by the content supplier . . .

89) Mobile telephony, Internet service or packet-switched service solution according to point 1, wherein the transactions are led in the different possible Bluetooth, Wlan, Wimax, GSM, or UMTS Wetting with NFC, Pin and more biometrical Fingerprint sensor—or linguistic identification or facial identification or with SMS transaction.

90) Mobile telephony, Internet service or packet-switched service solution according to point 1, wherein beside the financial transaction the personal identification is led for dependent on age or parental approval and parental control of Pin and more biometrical fingerprint sensor—or linguistic identification or facial identification.

91) Mobile phone ticketing solution according to point 1, wherein companies, institutions or organizations allow/give/operate/finance/lease/reward/require/penalize their employees/partners with regard to value-added services in the workplace, at home or on the road or together/jointly with/including other companies and institutions or organizations, and/or with regard to tickets/subscriptions/reductions corresponding to legal areas and/or products, services, duties, rights, promotions and contracts or businesses, whereby complete packets of WISP connection and routers are made available to said employees.

92) Mobile telephony, Internet service or packet-switched service after solution according point 1, wherein users of mobile Handhelds (mobile phone, PDAs, extension kits) on a radio (NFC, Bluetooth, Wlan) or physical interface with to a fixed network or other VoIP phone, VoIP terminal, VoIP monitor or in a telephone box can effect a phone call or initialize increase in value service (while, e.g., identify with the fingerprint-sensor).

93) Mobile phone ticketing solution according to point 1, wherein, in companies, especially banks or legal offices, the IT-based business and transactions of said companies which require legal documentation, especially stock exchange business and transactions, may be confirmed and time stamped for mobile phone users by biometric means, and wherein said transactions are encrypted and are themselves implemented as ticketing.

94) Mobile telephony, Internet service or packet-switched service according point 1, that can offer authorities or other institutions and organizations to their education documents, application documents liable to pay costs or commercial documents after solution in saying 1, wherein (about the web and Hotspots) train.

95) Mobile phone ticketing solution according to point 1, wherein advertising in value-added services makes said services more attractive for the user, by means of cross-subsidization, or wherein networks, portals or content are covered via advertising or other financing instruments such as donations, subscriptions, clubs, payments, and wherein any and all types of bundling all different offers, services, products, subscriptions or other values, rights and duties are offered.

96) Mobile telephony, Internet service or packet-switched service according to point 1, wherein bundles can be offered by different increase in value services in a subscription and as a Mobile-Ticketing licensing are pursued.

97) Mobile telephony, Internet service or packet-switched service according to point 1, wherein Mobile-Ticketing customers can acquire condition for the increase in value services (about our Payment) in different Access-Points, Wlan—to Bluetooth and UMTS nets etc. from different providers with other contract models and prize models one of the more favorable Roaming partners.

98) Mobile phone ticketing solution according to point 1, wherein mobile ticketing clients can pay for the respective content, value-added services, or even products/merchandise directly in Internet shops by means of our clearing solution via an appropriate link or a pertinent payment transaction solution, such as, for example, Saferpay, and wherein additional mobile ticketing value-added services can be offered thereby.

99) Mobile telephony, Internet service or packet-switched service according point 1, wherein companies, authorities, transport services, cities, municipalities, private will offer the Mobile-Ticketing also to other companies, authorities, traffic companies, cities, municipalities, private where, besides, the user has registered a clearly defined licensing/ticket in the device, which can be even immediately registered and be hosted on external servers of the ticket provider.

100) Mobile telephony, Internet service or packet-switched service according to point 1, wherein such suppliers on those or foreign servers will provide and offer the contents by P2P technology wherein just in the Access-Point-Firmware and/or the handsets/clients or to the server software for this management is integrated, or an interface or licensing is providing for external solutions.

101) Mobile telephony, Internet service or packet-switched service after solution according to point 1, wherein with competitions, offer-actions it is known to the customers by over time, locally, juridical communication on the handset and so the attention again is drawn to it in personally adjustable intervals.

102) Mobile telephony, Internet service or packet-switched service solution according to point 1, wherein with ticketing by rented vehicles, train or other entries, authorizations or licensing special general subscriptions are offered to the combined improved relation, consumption or purchase/rent of the services and wherein they are offered together with combined offered Internet value-added-services as a package or individually in the subscriptions.

1) Mobile radio and TV and multimedia, etc. Internet value-added service and packet-switched service ticketing solution, wherein, via WLAN, Bluetooth, GSM, UMTS, HSDPA, WiMax, DECT, UWB, UKW, satellite, DMB, DVB-H and NFC or any other mobile radio technology, a club system is operated, in which, from an Internet/radio/TV/telephone exchange platform with value-added services, content, multimedia and mobile VoIP, in one or more sessions by means of one or more/further (additional) hotspots, this mobile telephony and value-added service solution, whether charged individually and/or generally with the Internet connection, is operated for mobile telephone users, and wherein services which are subject to additional personal identification, such as PIN or biometric ID (fingerprint)—especially also at NFC terminals, etc.—payment, ticketing, Internet surfing, Internet TV, pay-TV, consumption-, registration-, authorization-, security-, time-, place-, and rights-dependent services and value-added services, such as premium SMS, Messenger or advertising, operated and/or offered to said users (on their devices)—especially in combination with other rights, duties and services for users, entitled and/or authorized parties (mobile hotspot value-added service users), whereby such hotspot ticketing, which is subject to a local fee and generates income for the operator, with tickets, subscriptions and other electronic vouchers, is operated on mobile telephones, and whereby any other type of authorization, participation, entitlement, purchase or acquisition, via the mobile telephone, of the IP value added services, such as Mobile VoIP, includes Internet, IP-TV, M-Payment, advertisement, mobile parking, lotteries, premium SMS, content as a whole and other such groups/bundles or reciprocal exclusions, such as content without advertising.

2) Mobile phone ticketing solution according to claim 1, wherein, in shops, restaurants, etc., said solution enables the mobile hotspot by US service users to obtain special offers, when they select the service with or without personal identification, and wherein advertisements and infomercials are switched in before, during and after the use of the mobile hotspot value-added service, according to specific user profiles, and wherein, in sports stadiums, replays or even Internet-TV can be displayed by means of this mobile hotspot value-added service offer, so that, along with a value-added service, and especially with a local and/or roaming VoIP, ticketing/vouchers/advertising for any other offer, or for any other value-added service, such as parking, IP-TV, M-Payment or VoIP itself, can be implemented/operated on the mobile phone.

3) Mobile phone ticketing solution according to claim 1, wherein, by means of said mobile hotspot value-added service offer, department store, public transportation, railway and stadium clients are given an alternative, including a mobile alternative, to (NFC Chip) payment and ticketing (i.e. are authorized and/or the tickets are charged), and along with this (PIN-SMS, email, etc.) ticketing, direct entitlement to said mobile hotspot value-added service offer in trains, stadiums, theaters, cinemas, etc., is provided and/or given and/or guaranteed, and wherein ticketing security and general personal security is enabled before entry, during transport and after exit, including directly for the providers (public transportation and stadium operators) (whereby said security, notwithstanding the fact that personal data are collected, guarantees data protection according to the basic principles of the operator and/or the network), thus enabling an (ingenious) possibility for operators of public and private transportation and football stadiums to control vandals, idlers and hooligans, (because) by ensuring that all of said mobile hotspot value-added service users, with authorizations installed on the mobile telephones, are always subjected to this ingenious means of control. 7)

4) Mobile phone ticketing solution according to claim 1, wherein, by means of Internet links to the video advertisements, access to the advertised Internet sites is provided, whereby, by clicking on the advertising link, a fee is collected, which must be paid by the advertiser to the mobile hotspot value-added service provider before the link is opened/forwarded, and wherein advertising links must be paid for according to click frequency, size and length, as they appear on the AIORK software, for which an (entirely transparent) AIORK calculation software performs the cost calculation for each advertising link, whereby predefined framework conditions with regard to fees are set for an advertising banner or advertising jingle, and whereby, in advertising spaces recognized in the free Web—which are not authorized by us, and which are visually and electronically marked—the finder receives a credit (e.g. 1% of the annual turnover of the advertising link, or a lump sum) and the same fee principle applies to all other Internet services offered via mobile hotspot value-added services; otherwise, the payment, ticketing and all other control and security services, or precisely the entire hotspot, are blocked/discriminated by the AIORK software. 18)

5) Mobile phone ticketing solution according to claim 1, wherein private hotspot operators offer advertisement and mobile hotspot value-added services (as is already claimed in the AIORK patent)—both without and with identification/control or ticketing/payment. In other words, any combination and/or exclusions of advertising+mobile services, advertising+identification/control, advertising+ticketing/payment, identification/control+mobile services, identification/control+ticketing/payment, mobile services+ticketing/payment, mobile services+ticketing/payment+identification/control, mobile services+identification/control+advertising, ticketing/payment+identification/control+advertising or mobile services+ticketing/payment+identification/control+advertising, is possible.

6) Mobile phone ticketing solution according to claim 1, wherein ticketing is used in bars, clubs and restaurants, etc., whereby appropriate mobile hotspot value-added services are offered for competitions with tickets or, for example, beverage credits, whereby said mobile hotspot value-added services can be obtained by means of the dial-in ticket code visible on the TV, flyers, beer mats, etc. and, against identification, additional (free or reduced-Price) offers of beverages and food can be obtained. 26)

7) Mobile phone ticketing solution according to claim 1, wherein, for mobile parking ticketing, unoccupied parking places are announced and reserved on the mobile telephones by means of all radio standards, and wherein said ticketing can also be operated online, with the same reservations, in and with cinemas, airplanes, trains, restaurants, and wherein automobile drivers can simultaneously obtain the mobile ticketing Internet services while in the parking garage. 48)

8) Mobile phone ticketing solution according to claim 1, wherein a link (against a fee), or a function for obtaining good free offers, is integrated into the mobile ticketing, and wherein free content constitutes a form of value-added services which requires a license. 49)

9) Mobile phone ticketing solution according to claim 1, wherein, for unidirectional transmission media, such as VHF radio or terrestrial, digital (DVBH) or satellite TV, via/with/upon mobile ticketing via WLAN or Bluetooth Hotspots and/or GSM and UMTS networks, feedback messages for all additional services are allowed to reach the unidirectional transmission media, whereby (for example), upon/for/after advertising, direct purchase/voting/reservation is possible. 61)

10) Mobile phone ticketing solution according to claim 1, wherein, in hotspots in public and private places, public authorities, schools, companies, shops, etc., handsets and especially extension kits are configured to specific user rights and the users and/or their handsets can be charged with fines/penalties or tariffs, against a fee, and wherein especially any user traffic can be individually controlled by the hotspot operator. 68)

11) Mobile phone ticketing solution according to claim 1, wherein mobile ticketing may be understood to include mobile paying, i.e. wherever direct—especially NFC and SMS—payments are made, VAS for which a fee is charged are subject to license fees, or wherein, instead of individual charging for VAS, a time-based (leasing) system of charging for VAS may be activated. 69)

12) Mobile phone ticketing solution according to claim 1, wherein, in hotspots, services with subscriptions or flat rates or free offers, or also sponsored services subsidized, for example, by advertising, may be combined with each other and roamed in local or foreign networks, whereby the concept of ticketing is decisive: Should an electronic ticket (billed or free authorization) be generated, the service applies to the user in question in all hotspots, and is cleared by a company, or may also be cleared by a plurality of (independent or sponsored) companies. Should a user in or from a GSM/UMTS network enter a WLAN network with a more attractive tariff or sponsored service, the client selects and switches in, by means of the mobile telephone, the most attractive, best or fastest provider (GSM, UMTS or WLAN), whereby said provider does not only clear said services individually at the most attractive rate, but may also provide them at a flat rate or as sponsored services. Should a client leave a sponsored or free or pay as you go hotspot and roam into a local or foreign pay-as-you-go or free network, said user shall again perform ticketing in said network as a service. 78)

13) Mobile phone ticketing solution according to claim 1 (80), wherein the VAS that are offered via a hotspot (WLAN, Bluetooth, NFC) in the territory in question are subject to a license fee, even if the ticketing was applied to the device by means of another hotspot (UMTS, GSM). This shall also apply to users who hopped into WLAN networks or via interconnected WLAN networks with OLSR protocol into a local MAN network—for example, from WLAN via WIMAX to WLAN, and are thereby connected by means of a hybrid network. 81)

14) Mobile phone ticketing solution according to claim 1, wherein companies, institutions or organizations allow/give/operate/finance/lease/reward/require/penalize their employees/partners with regard to value-added services in the workplace, at home or on the road or together/jointly with/including other companies and institutions or organizations, and/or with regard to tickets/subscriptions/reductions corresponding to legal areas and/or products, services, duties, rights, promotions and contracts or businesses, whereby complete packets of wISP connection and routers are made available to said employees. 91)

15) Mobile phone ticketing solution according to claim 1, wherein, in companies, especially banks or legal offices, the IT-based business and transactions of said companies which require legal documentation, especially stock exchange business and transactions, may be confirmed and time stamped for mobile phone users by biometric means, and wherein said transactions are encrypted and are themselves implemented as ticketing. 93)

16) Mobile phone ticketing solution according to claim 1, wherein advertising in value-added services makes said services more attractive for the user, by means of cross-subsidization, or wherein networks, portals or content are covered via advertising or other financing instruments such as donations, subscriptions, clubs, payments, and wherein any and all types of bundling all different offers, services, products, subscriptions or other values, rights and duties are offered. 95)

17) Mobile phone ticketing solution according to claim 1, wherein mobile ticketing clients can pay for the respective content, value-added services, or even products/merchandise directly in Internet shops by means of our clearing solution via an appropriate link or a pertinent payment transaction solution, such as, for example, Saferpay, and wherein additional mobile ticketing value-added services can be offered thereby. 98)

18) Mobile phone ticketing solution according to claim 1, wherein, for ticketing related to rental cars, products, services, railway or other transportation, authorizations or entitlements, special comprehensive subscriptions/tickets can be offered for attractively priced combined acquisition, consumption and/or purchase/rental of the services in question, and wherein the thereby jointly offered Internet value-added services are offered as a package or individually in the subscriptions/tickets. 103)
